(19) United States
(12) Patent Application Publication
(10) Pub. No.: US 2007/0192383 A1
(43) Pub. Date: Aug. 16, 2007

(54) Extension specified undo transactions

(75) Inventors: Timothy B. Harahan, Seattle, WA (US); Yohay B. Voronov, Kirkland, WA (US); Alexander A. Sourov, Seattle, WA (US); Marcel P.F. Parent, Hamilton (CA)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/344,576

(22) Filed: Jan. 31, 2006

(51) Int. Cl. G06F 17/30

(52) U.S. Cl. 707/202

(57) ABSTRACT

Systems and methods are disclosed for providing extension specified undo transactions. The disclosed systems and methods may include receiving a first plurality of operations from an extension. The first plurality of operations may include a first open undo transaction command and a first close undo transaction command. The first plurality of operations may correspond to one event being completely specified by the first plurality of operations. No other data may be required to specify the event. Furthermore, the disclosed systems and methods may include receiving a first undo command. In addition, the disclosed systems and methods may include undoing all operations received between the first open undo transaction command and the first close undo transaction command in response to the received first undo command.

### BACKGROUND

Many application programs have an “undo” feature. For example, a user can perform operations in an application program, and, if unhappy with the result, press one button to undo the operations. Most application programs with undo features deliver one-touch undo user input taken through a user interface (U1) associated with the application program. Few application programs, however, handle user undo actions taken through, for example, extensions. An extension is a software module that sends commands to an application program (e.g. a parent application) through the application program's object model. A Visual Basic for Applications (VBA) macro from MICROSOFT CORPORATION of Redmond, Washington, is an example of an extension.

An extension's UI for example, can be made indistinguishable from a parent application's user interface. In other words, the user may not know if a particular UI is associated with an extension or with the extension's parent application. For example, a solution provider may create a macro (e.g. an extension) that performs many operations in conjunction with an application program. Then the solution provider may add a button to a user's desktop UI that runs the macro when the button is pressed. Accordingly, the user may see the macro as part of their desktop and consequently expect it to have the same one-touch undo that operations native to the parent application program may have. In other words, because the user does not know which buttons on their desktop may be associated with a macro or with a parent application program, the user may expect the same undo functionality with all aspects of their desktop UI.

In view of the foregoing, there is a need for methods and systems for providing extension specified undo transactions. Furthermore, there is a need for providing extension specified undo transactions using, for example, open and close batching of extension actions into undoable units.

### SUMMARY

Systems and methods are disclosed for providing extension specified undo transactions. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one embodiment, a method for providing extension specified undo transactions may include receiving a first plurality of operations from an extension. The first plurality of operations may include a first open undo transaction command and a first close undo transaction command. In addition, the first plurality of operations may correspond to one event being completely specified by the first plurality of operations. No other data may be required to specify the event. Furthermore, the method may include receiving a first undo command. In addition, the method may include undoing all operations received between the first open undo transaction command and the first close undo transaction command in response to the received first undo command.

According to another embodiment, a system for providing extension specified undo transactions. The system may comprise a memory storage for maintaining a database and a processing unit coupled to the memory storage. The processing unit may be operative to receive a first plurality of operations from an extension. The first plurality of operations may include a first open undo transaction command and a first close undo transaction command. Also, the first plurality of operations may correspond to one event being completely specified by the first plurality of operations. No other data may be required to specify the event. In addition, the processing unit may be operative to receive a first undo command. Furthermore, the processing unit may be operative to undo all operations received between the first open undo transaction command and the first close undo transaction command in response to the received first undo command.

In accordance with yet another embodiment, a computer-readable medium which stores a set of instructions which when executed performs a method for providing extension specified undo transactions. The method may be executed by the set of instructions. The set of instructions may include receiving a first plurality of operations from an extension. The first plurality of operations may include a first open undo transaction command and a first close undo transaction command. In addition, the first plurality of operations may correspond to one event being completely specified by the first plurality of operations. No other data may be required to specify the event. Furthermore, the set of instructions may include receiving a first undo command. In addition, the set of instructions may include undoing all operations received between the first open undo transaction command and the first close undo transaction command in response to the received first undo command.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary system including a computing device consistent with an embodiment of the present invention;

FIG. 2A illustrates conventional extension code operations;

FIG. 2B illustrates extension code operations consistent with an embodiment of the present invention;

FIG. 3A illustrates an undo stack consistent with an embodiment of the invention;

FIG. 3B illustrates a parsing algorithm consistent with an embodiment of the invention;

FIG. 4 illustrates an undo algorithm consistent with an embodiment of the present invention; and

FIG. 5 is a flow chart of an exemplary method for providing extension specified undo transactions consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims

Systems and methods consistent with embodiments of the present invention provide extension specified undo transactions. Consistent with embodiments of the invention, extensions can specify undo transactions, for example, with an open and close call that may allow extension action batching into one-touch undo units. Furthermore, embodiments of the invention may allow multiple nested start and stop pairs. For example, extension writers may not need to worry about whether they foul their one-touch undo if one extension script, containing an open and close pair, calls some other extension function with a open and close of its own. If the extension, for example, calls a close undo transaction without a matching open, an undo stack may be cleared.

With conventional processes, a user could press a first button corresponding to a first extension causing six operations to be sent a parent application. Then the user could also press a second button twice sending three operations to the parent application on each second button press. Consequently, the parent application may have no way of telling which operation(s) came from which press of which extension's button. Accordingly, the parent application cannot undo just the operations from the second push of the second button like the user may expect. To counter this problem, conventional systems require users to define undo batches using other data such as batch management objects or by inserting bookmark records into an undo stack. In contrast with conventional systems, embodiments of the present invention do not require such other data thus enabling undo, for example, without the overhead of extra objects or the wasted space of bookmarks. For example, consistent with embodiments of the present invention, the aforementioned problem may be solved, for example, by giving extensions two new object model commands: i) “OpenUndoTransaction” and ii) “CloseUndoTransaction”.

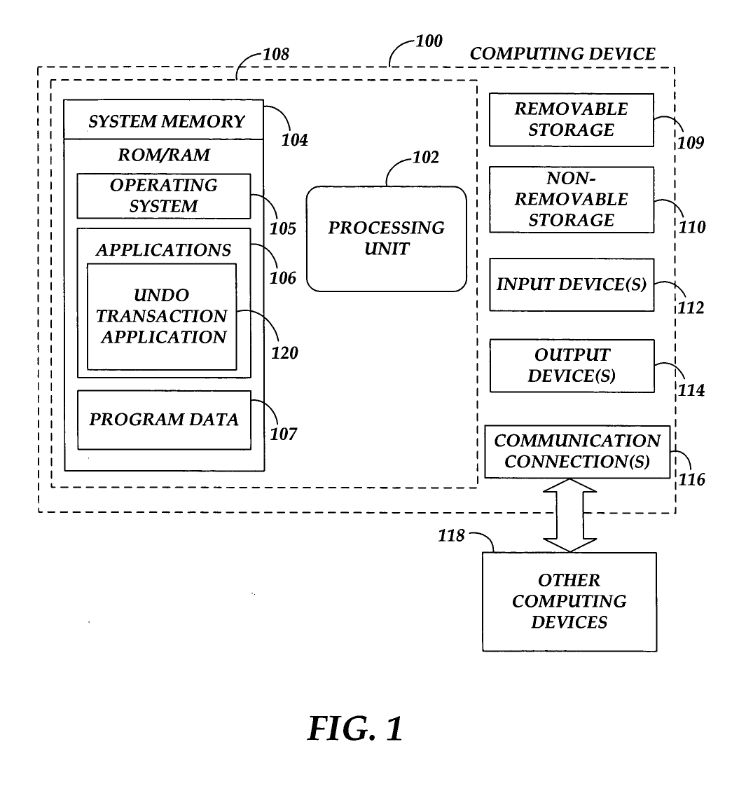

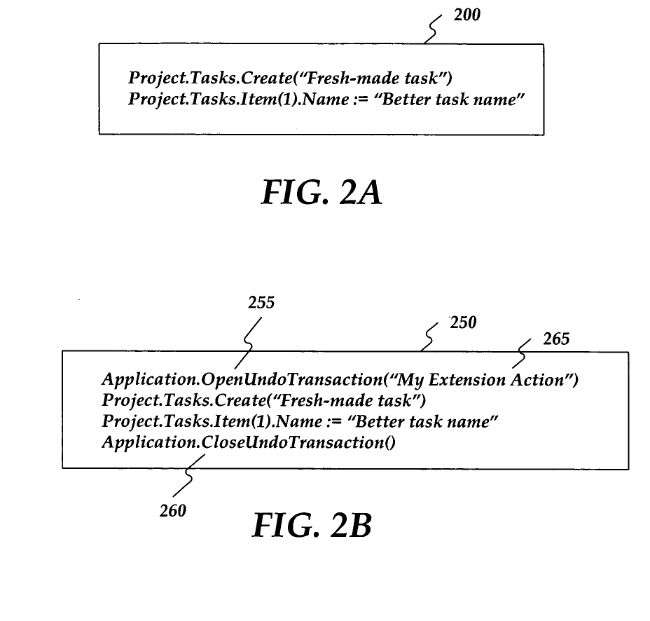

Embodiments of the invention may be practiced, for example, in a computing device 100 as shown in FIG. 1 and described in greater detail below. Computing device 100 is exemplary and other operating environments may be used consistent with embodiments of the invention. FIG. 2A illustrates a conventional extension code operations 200 that may not be handled by one-touch undo. FIG. 2B illustrates extension code operations 250 consistent with an embodiment of the present invention. For example, extension code operations 250 may include an OpenUndoTransaction command 255 and a CloseUndoTransaction command 260. All operations between OpenUndoTransaction command 255 and CloseUndoTransaction command 260 may be grouped into one batch. This grouped batch may appear in an undo dropdown of the parent application program associated with extension code operations 250. Moreover, this grouped batch may appear as one event with a label 265 specified in OpenUndoTransaction command 255 and may be one-touch undone. Label 265 may comprise, but is not limited to, a globally unique identifier (GUID) or a text string. The aforementioned are exemplary and other elements may comprise label 265.

A GUID may comprise a unique 128-bit number that is produced by operating system 105 or by some other application in application 106 to identify, for example, a particular component, application, file, database entry, and/or user. For example, a website may generate a GUID and assign it to a user's browser to record and track the session. GUIDs can be created in a number of ways, but usually they are a combination of a few unique settings based on specific point in time.

An application program consistent with embodiments of the invention may include a multiple undo process that may use a change tracking process to discover what data changed as a result of any given user action. For example, a record of everything as a result of one command, plus the before and after values of any changed data may comprise one undo transaction record. Moreover, each command (or group of commands that may appear to an extension user to be one operation) issued by the extension through the application program may generate one such undo transaction record as well.

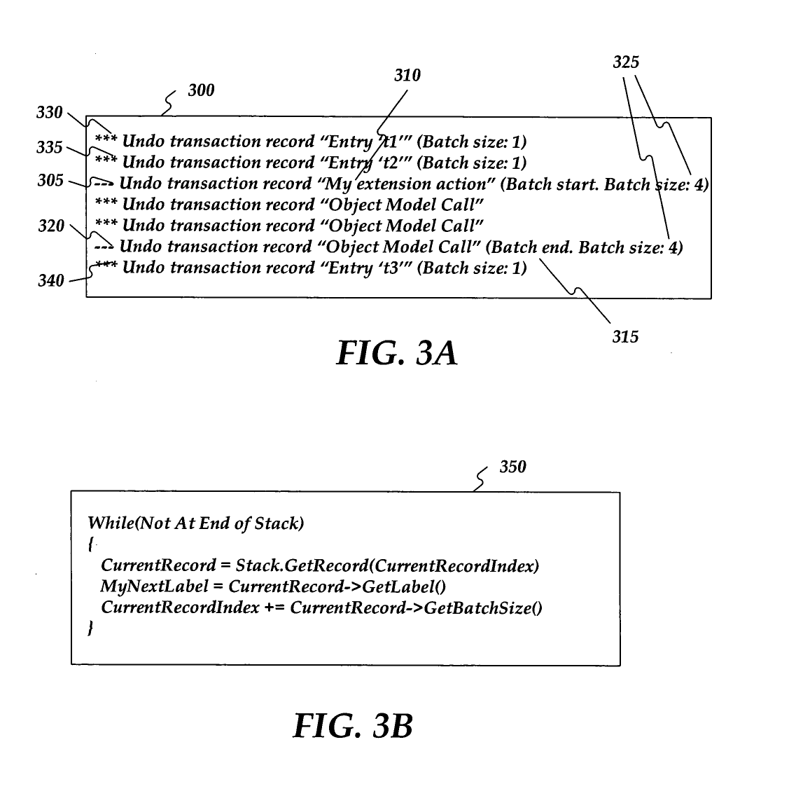

FIG. 3A illustrates an undo stack 300 consistent with an embodiment of the invention. For example, extension code operations 250 may be received by an application program consistent with embodiments of the invention. As a result, the application program may place operations associated with extension code operations 250 in an undo stack 200. OpenUndoTransaction command 255, within extension code operations 250, may have three effects on undo stack 300 associated with the application program. First, an extension batching “refcount” may be incremented in response to OpenUndoTransaction command 255. Incrementing “refcount” may allow nested open undo transaction and close undo transaction calls to still form a single one-touch undo unit. Second, a first undo transaction record 305 may be created in stack 300 corresponding to OpenUndoTransaction command 255. First undo transaction record 305 may be tagged as the start of a batch corresponding to extension code operations 250. And third, a batch label 310 may stored in next undo transaction record 305. Batch label 310 may correspond to label 265 associated with extension code operations 250, for example, label 265.

CloseUndoTransaction command 260 may have two effects. First, an “end-of-batch” flag 315 may be set on the more recently created undo transaction record (i.e. a last undo transaction record 320.) And second, a number of records 325 in the batch corresponding to extension code operations 250 may be cached on the undo transaction records at the start and end of the batch to, for example, speed jumps between the two.

Consistent with embodiments of the invention, whenever an undo command causes the undo stack to be parsed, batches may be treated as units. Batches included in undo stack 300, for example, may include batches 330, 335, 340, and the batch between first undo transaction record 305 and last undo transaction record 320. Embodiments of the invention may parse undo stack 300 as it is populated with transaction record labels according, for example, to a parsing algorithm 350 as shown in FIG. 3B.

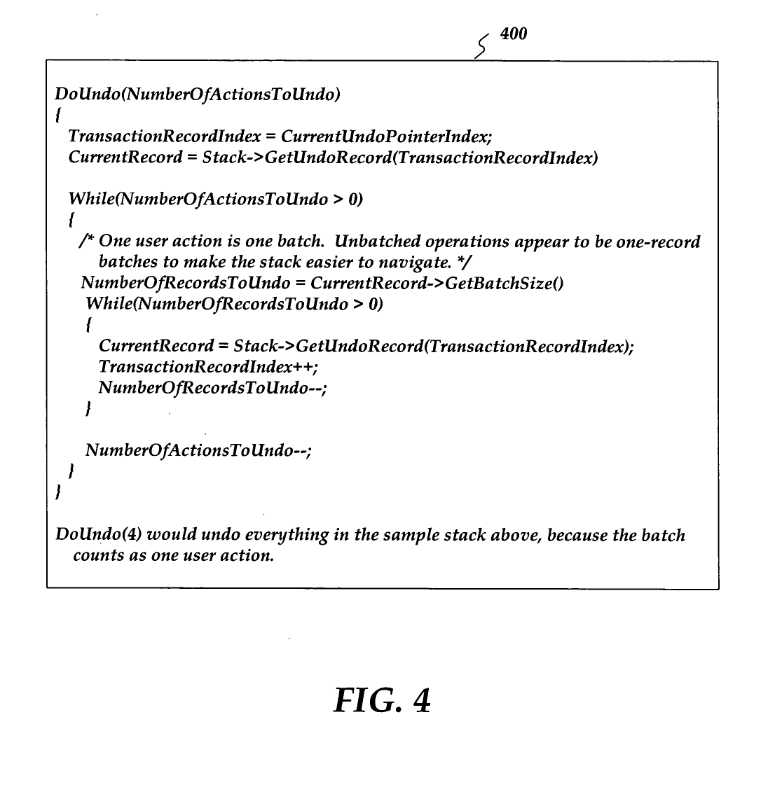

Consistent with embodiments of the invention, an undo button input may apply the records as shown in undo stack 300 according to an undo algorithm 400 shown in FIG. 4. For example, a batch start and a batch end record may return an “OpenUndoTransaction-specified” label stored in the batch start label on, for example, a GetLabel call. Every record between the batch start and the batch end record may get skipped by algorithm 400, because algorithm 400 may skip to a first post-batch record once it gets its label. A redo algorithm may work the same way, just counting down from the top record rather than up from the last one. This may let the batches appear as one entry in the undo or a redo stack. Stack 300 may include batch 330 labeled “Entry t1”, batch 335 labeled “Entry t2”, batch 340 labeled “Entry t3”, and the batch between first undo transaction record 305 and last undo transaction record 320 labeled “My extension action”.

An embodiment consistent with the invention may comprise a system for providing extension specified undo transactions. The system may comprise a memory storage for maintaining a database and a processing unit coupled to the memory storage. The processing unit may be operative to receive a first plurality of operations from an extension. The first plurality of operations may include a first open undo transaction command and a first close undo transaction command. The first plurality of operations may correspond to one event being completely specified by the first plurality of operations. No other data may be required to specify the event. In addition, the processing unit may be operative to receive a first undo command. Furthermore, the processing unit may be operative to undo all operations received between the first open undo transaction command and the first close undo transaction command in response to the received first undo command.

Consistent with an embodiment of the present invention, the aforementioned memory, processing unit, and other components may be implemented in a computing device, such as an exemplary computing device 100 of FIG. 1. Any suitable combination of hardware, software, and/or firmware may be used to implement the memory, processing unit, or other components. By way of example, the memory, processing unit, or other components may be implemented with any of computing device 100 or any of other computing devices 118, in combination with computing device 100. The aforementioned system, device, and processors are exemplary and other systems, devices, and processors may comprise the aforementioned memory, processing unit, or other components, consistent with embodiments of the present invention.

Generally, program modules may include routines, programs, components, data structures, and other types of structures that perform particular tasks or implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system consistent with an embodiment of the invention may include a computing device, such as computing device 100. In a basic configuration, computing device 100 may include at least one processing unit 102 and a system memory 104. Depending on the configuration and type of computing device, system memory 104 may be volatile (such as RAM), non-volatile (such as ROM, flash memory, etc.) or some combination. System memory 104 may include an operating system 105, one or more applications 106, and may include a program data 107. In one embodiment, applications 106 may include an undo transaction application 120. However, embodiments of the invention may be practiced in conjunction with a graphics library, an operating system, or any application program and is not limited to any particular application or system. This basic configuration is illustrated in FIG. 1 by those components within a dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by a removable storage 109 and a non-removable storage 110. Computer storage media may include volatile and nonvolatile, removable and non-removable media implemented in any method or technology for storage of information, such as computer readable instructions, data structures, program modules, or other data. System memory 104, removable storage 109, and non-removable storage 110 are all examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. The aforementioned devices are exemplary and others may be used.

Computing device 100 may also contain a communication connection 116 that may allow device 100 to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein may include both storage media and communication media.

A number of program modules and data files may be stored in system memory 104 of computing device 100, including an operating system 105 suitable for controlling the operation of a networked personal computer, such as the WINDOWS operating systems from MICROSOFT CORPORATION of Redmond, Washington. System memory 104 may also store one or more program modules, such as undo transaction application 120, and others described below. While executing on processing unit 102, undo transaction application 120 may perform processes including, for example, one or more of the stages of the methods described below. The aforementioned process is exemplary, and processing unit 102 may perform other processes. Other applications 106 that may be used in accordance with embodiments of the present invention may include, but not limited to, electronic mail and contacts applications, word processing applications, spreadsheet applications, database applications, slide presentation applications, drawing or computer-aided application programs, and project planning applications.

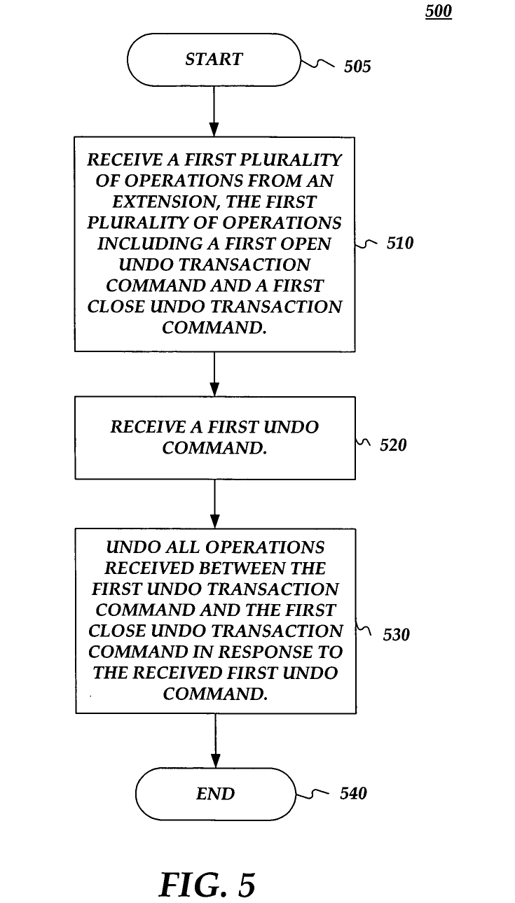

FIG. 5 is a flow chart setting forth the general stages involved in an exemplary method 500 consistent with the invention for providing extension specified undo transactions using system 100 of FIG. 1. Exemplary ways to implement the stages of exemplary method 500 will be described in greater detail below. Exemplary method 500 may begin at starting block 505 and proceed to stage 510 where computing device 100 may receive a first plurality of operations from an extension. The first plurality of operations may include a first open undo transaction command and a first close undo transaction command. For example, the extension may be operating on computing device 100 and may provide extension code operations 250 to undo transaction application 120. For example, extension code operations 250 (e.g. the first plurality of operations) may include OpenUndoTransaction command 255 (e.g. the first open undo transaction command) and CloseUndoTransaction command 260 (e.g. the first close undo transaction command). All operations between OpenUndoTransaction command 255 and CloseUndoTransaction command 260 may be grouped into one batch. This grouped batch may appear in an undo dropdown of a parent application program (running undo transaction application 120 for example) associated with extension code operations 250.

Moreover, this grouped batch may appear as one event with the label specified in OpenUndoTransaction command 255 and may be one-touch undone. In other words, while this grouped batch may include a number of operations for the parent application, a user, supplying input to the extension, the number of operations may be perceived to be just one event. For example, the first plurality of operations (e.g. extension code operations 250) may correspond to one event being completely specified by the first plurality of operations. No other data may be required to specify the event. Conventional systems ask users to define undo batches by creating batch management objects or by inserting bookmark records into an undo stack. Embodiments of the invention do not require such other data thus enabling undo, for example, without the overhead of extra objects or the wasted space of bookmarks.

From stage 510, where computing device 100 receives the first plurality of operations from the extension, exemplary method 500 may advance to stage 520 where computing device 100 may receive a first undo command. For example, a user may be operating the application program and the extension on computing device 100. While the user may not know which operations are being performed by the application program or the extension, the user may wish to undo some operations recently entered into computing device 100. Accordingly, the user may use one of input devices 112 to enter the first undo command in order to undo some operations recently entered into computing device 100.

Once computing device 100 receives the first undo command in stage 520, exemplary method 500 may continue to stage 530 where computing device 100 may undo all operations received between the first open undo transaction command and the first close undo transaction command in response to the received first undo command. For example, as stated above, the undo command may cause an undo stack to be parsed as batches. Batches in the undo stack may be treated as units and may be undone and redone as units. For example, a series of operations may be performed by the extension that appear to be one operation to the user. When the extension sends the series of operations to the application program, the series of operations may be placed in the application program's undo stack as one unit or batch. The batch's start may be indicated by an OpenUndoTransaction command and the batch's end may be indicated by a CloseUndoTransaction command. After computing device 100 undoes all operations received between the first open undo transaction command and the first close undo transaction command in stage 530, exemplary method 200 may then end at stage 540.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed is:

1. A method for providing extension specified undo transactions for an application, the method comprising:
receiving a first plurality of operations from an extension, the first plurality of operations including a first open undo transaction command and a first close undo transaction command, the first plurality of operations being considered as one event by an application user, the one event being completely specified by the first plurality of operations with no other data being required to specify the one event;
receiving a first undo command; and
undoing all operations received between the first open undo transaction command and the first close undo transaction command in response to the received first undo command.

2. The method of claim 1, further comprising:
receiving a second plurality of operations from an extension prior to receiving the first undo command, the second plurality of operations including a second open undo transaction command and a second close undo transaction command;
receiving a second undo command prior to receiving the first undo command; and
undoing, prior to receiving the first undo command, all operations received between the second open undo transaction command and the second close undo transaction command in response to the received second undo command.

3. The method of claim 1, wherein receiving the first plurality of operations from the extension further comprises incrementing, in response to the first open undo transaction command, an extension batching refcount.

4. The method of claim 1, wherein receiving the first plurality of operations from the extension further comprises tagging, in response to the first open undo transaction command, a first undo transaction record as a start of a batch within an undo stack, the batch corresponding to the first plurality of operations.

5. The method of claim 4, wherein tagging, in response to the first open undo transaction command, the first undo transaction record as the start of the batch within the undo stack further comprises storing a batch label corresponding to the batch in the first undo transaction record.

6. The method of claim 1, further comprising setting an end-of-batch flag on a last undo transaction record, the last undo transaction record corresponding to a last operation in a batch within an undo stack, the batch corresponding to the first plurality of operations.

7. The method of claim 1, further comprising caching a number of records in a batch on a first undo transaction record at a start of the batch and on a last undo transaction record at an end of the batch, the batch corresponding to the first plurality of operations.

8. A system for providing extension specified undo transactions, the system comprising:
a memory storage for maintaining a database; and
a processing unit coupled to the memory storage, wherein the processing unit is operative to:
receive a first plurality of operations from an extension, the first plurality of operations including a first open undo transaction command and a first close undo transaction command, the first plurality of operations corresponding to a one event being completely specified by the first plurality of operations with no other data being required to specify the one event;
receive a first undo command; and
undo all operations received between the first open undo transaction command and the first close undo transaction command in response to the received first undo command.

9. The system of claim 8, wherein the processing unit operative to receive the first plurality of operations from the extension further comprises the processing unit operative to increment, in response to the first open undo transaction command, an extension batching refcount.

10. The system of claim 8, wherein the processing unit operative to receive the first plurality of operations from the extension further comprises the processing unit operative to tag, in response to the first open undo transaction command, a first undo transaction record as a start of a batch within an undo stack, the batch corresponding to the first plurality of operations.

11. The system of claim 10, wherein the processing unit operative to tag, in response to the first open undo transaction command, the first undo transaction record as the start of the batch within the undo stack further comprises the processing unit operative store a batch label corresponding to the batch in the first undo transaction record.

12. The system of claim 8, further comprising the processing unit operative to set an end-of-batch flag on a last undo transaction record, the last undo transaction record corresponding to a last operation in a batch within an undo stack, the batch corresponding to the first plurality of operations.

13. The system of claim 8, further comprising the processing unit operative to cache a number of records in a batch on a first undo transaction record at a start of the batch and on a last undo transaction record at an end of the batch, the batch corresponding to the first plurality of operations.

14. A computer-readable medium which stores a set of instructions which when executed performs a method for providing extension specified undo transactions, the method executed by the set of instructions comprising:
receiving a first plurality of operations from an extension, the first plurality of operations including a first open undo transaction command and a first close undo transaction command, the first plurality of operations corresponding to a one event being completely specified by the first plurality of operations with no other data being required to specify the one event;
receiving a first undo command; and
undoing all operations received between the first open undo transaction command and the first close undo transaction command in response to the received first undo command.

15. The computer-readable medium of claim 14, further comprising:
receiving a second plurality of operations from an extension prior to receiving the first undo command, the second plurality of operations including a second open undo transaction command and a second close undo transaction command;
receiving a second undo command prior to receiving the first undo command; and
undoing, prior to receiving the first undo command, all operations received between the second open undo transaction command and the second close undo transaction command in response to the received second undo command.

16. The computer-readable medium of claim 14, wherein receiving the first plurality of operations from the extension further comprises incrementing, in response to the first open undo transaction command, an extension batching refcount.

17. The computer-readable medium of claim 14, wherein receiving the first plurality of operations from the extension further comprises tagging, in response to the first open undo transaction command, a first undo transaction record as a start of a batch within an undo stack, the batch corresponding to the first plurality of operations.

18. The computer-readable medium of claim 17, wherein tagging, in response to the first open undo transaction command, the first undo transaction record as the start of the batch within the undo stack further comprises storing a batch label corresponding to the batch in the first undo transaction record.

19. The computer-readable medium of claim 14, further comprising setting an end-of-batch flag on a last undo transaction record, the last undo transaction record corresponding to a last operation in a batch within an undo stack, the batch corresponding to the first plurality of operations.

20. The computer-readable medium of claim 14, further comprising caching a number of records in a batch on a first undo transaction record at a start of the batch and on a last undo transaction record at an end of the batch, the batch corresponding to the first plurality of operations.
